(19) United States
(12) Patent Application Publication
(10) Pub. No.: US 2009/0087036 A1
(43) Pub. Date: Apr. 2, 2009

(54) Pattern Matching Method, Pattern Matching System, and Pattern Matching Program

(75) Inventor: Hitoshi Imaoka, Tokyo (JP)

Correspondence Address: FOLEY AND LARDNER LLP;SUITE 500, 3000 K STREET NW, WASHINGTON, DC, 20007, US

(73) Assignee: NEC CORPORATION, TOKYO (JP)

(21) Appl. No.: 11/921,323

(22) PCT Filed: May 25, 2006
(86) PCT No.: PCT/JP2006/310478

§ 371 Date: Nov. 30, 2007

(30) Foreign Application Priority Data
May 31, 2005 (JP) 2006-158778

(51) Int. Cl. G06K 9/00

(52) U.S. Cl. 382/118

(57) ABSTRACT

A variation image generation means generates a plurality of variation images having different postures, facial positions, and sizes with respect to a normalized image. A characteristic extraction means extracts a frequency characteristic from the plurality of variation images. A discriminant space projection means projects the frequency characteristic on a discriminant space having high discriminant ability that is obtained by linear discriminant analysis. A reference person comparison means performs a reference person comparison to extract a highly discriminant characteristic. A discriminant characteristic is extracted for a match image using the characteristic extraction means and the discriminant space projection means. A score computation means uses a discriminant axis obtained from a registered image, and the discriminant characteristic obtained from the match image to output a match score. A match determination means determines whether the person is the same person by comparing the match score with a threshold value.

### TECHNICAL FIELD

The present invention relates to a pattern matching method for matching the pattern of a facial image on the basis of characteristics of the facial image, to a pattern matching system, and to a pattern matching program. The present invention also relates to an image characteristic extraction method for extracting the characteristics of a facial image, to an image characteristic extraction system, to an image characteristic extraction device, and to an image characteristic extraction program.

### BACKGROUND ART

Conventional methods are known that use physical characteristics of an individual to distinguish between a subject and another person in entrance/exit management systems, systems that use access control, and other security systems. A method of authentication using a facial image is an example of a person identification method that utilizes physical characteristics. In a method of authentication by facial image, a facial image captured by a camera or the like is compared with a facial image that is registered in advance in a database or the like to verify the identity of a subject. However, in a method of authentication by facial image, the orientation of the face or the lighting conditions, the date and time at which the image was captured, and other effects generally make it impossible to obtain a high degree of identification performance merely by superposing the inputted image on the registered image to compare a match score.

A method referred to as the Eigenface method (see Non-patent Document 1) is commonly known as a matching method that uses a facial image. In the Eigenface method described in Non-patent Document 1, the sizes of images in an image collection are normalized, and a subspace of a characteristic vector composed of gradation values of the pixels of the images is generated by principal component analysis. Characteristic vectors of the input image and the registered image are projected onto the subspace to calculate a match score. A determination is made as to the identity of the subject under authentication on the basis of the calculated match score. However, in the Eigenface method described in Non-patent Document 1, not only are image variations within the same person suppressed, but image variations between different people are suppressed when the characteristic vector is projected onto the subspace. Therefore, a high degree of identification performance is not necessarily obtained when verification is performed using facial images.

The method (see Non-patent Document 2) referred to as the Fisherface method was proposed in order to overcome the problems of the Eigenface method. In the Fisherface method described in Non-patent document 2, each individual is assigned to a single class when there is a plurality of individuals. A subspace is constructed using a method (linear discriminant analysis) in which the in-class dispersion between numerous people is reduced, and the dispersion between classes is increased. Characteristic vectors of the input image and the registered image are projected onto the subspace to calculate a match score. A determination is made as to the identity of the subject under authentication on the basis of the calculated match score. In the Fisherface method described in Non-patent Document 2, a higher degree of precision than that of the Eigenface method has been confirmed by match experimentation using facial images when there are a sufficient number of learning sample images for obtaining an intra-class covariance matrix and an inter-class covariance matrix.

Non-patent Document 1: M. Turk, A. Pentland, “Eigenfaces for recognition,” Journal of Cognitive Neuroscience, Vol. 3, No. 1, pp. 71-86, 1991.

Non-patent Document 2: W. Zhao, R. Chellappa, P. J. Philips, “Subspace linear discriminant analysis for face recognition,” Tech. Rep. CAR-TR-914, Centre for Automation Research, University of Maryland, College Park, 1999.

### DISCLOSURE OF THE INVENTION

### Problems the Invention is Intended to Solve

The Fisherface method described in Non-patent Document 2 is known for being able to distinguish between the faces of one person and another with high precision when the facial images for learning, which are used when the intra-class covariance matrix and the inter-class covariance matrix are calculated, are used as facial images for registration/matching (registered images for matching). However, in general, even when the identifying capability is high when matching is performed with the learning facial images, the identifying capability is not necessarily high when matching is performed with registration/matching facial images other than the learning facial images. There is therefore a possibility of not obtaining high identification capability during facial image matching when facial images other than the learning facial images are registered as the registration/learning facial images. Varying components due to individual posture, illumination, and the like between people in the registration/matching images must also be taken into account in order to match the identity of a subject with high precision.

Therefore, an object of the present invention is to provide an image characteristic extraction method capable of performing high-precision identity matching using a facial image by considering posture, illumination, or other variation components for each registered person, and to provide a pattern matching method, an image characteristic extraction system, a pattern matching system, an image characteristic extraction device, an image characteristic extraction program, and a pattern matching program.

### Means for Solving the Problems

The image characteristic extraction method of the present invention is an image characteristic extraction method for extracting a characteristic of a facial image that is used to match a facial image pattern, wherein the image characteristic extraction method is characterized in comprising a variation image generation step for generating a plurality of variation images in which a prescribed variation is added to a facial image; and an image characteristic quantity extraction step for extracting a characteristic of a facial image being processed, by calculating a prescribed characteristic quantity (e.g., a discriminant vector u, or parameters a and b) for distinguishing between a person in the facial image being processed and a prescribed reference person on the basis of the generated variation images. The object of the present invention can be achieved by employing such a configuration as the one described above to determine whether the abovementioned people match.

The pattern matching method of the present invention is a pattern matching method for matching a facial image pattern on the basis of a facial image characteristic, wherein the pattern matching method is characterized in comprising a variation image generation step for generating a plurality of variation images in which a prescribed variation is added to a facial image; and an image characteristic quantity extraction step for extracting a characteristic of a facial image being processed, by calculating a prescribed characteristic quantity for distinguishing between a person in the facial image being processed and a prescribed reference person on the basis of the generated variation images. The object of the present invention can be achieved by employing such a configuration as the one described above to determine whether the abovementioned people match.

The pattern matching method may also include a score computation step for comparing a characteristic of a registered image that is a pre-registered facial image, and of a match image that is a facial image being matched, and calculating a score (e.g., a match score S₁) that indicates a degree of agreement in the characteristic between the registered image and the match image on the basis of the extracted facial image characteristic; and a match determination step for determining whether a person in the registered image and a person in the match image are the same person by comparing the calculated score with a prescribed threshold value.

The pattern matching method may also be a pattern matching method for matching a pattern of a facial image on the basis of facial image characteristic, wherein the pattern matching method comprises a first variation image generation step for generating a plurality of variation images in which a prescribed variation is added to a registered image that is a pre-registered facial image; a first image characteristic quantity extraction step for extracting a characteristic of the registered image by calculating a prescribed characteristic quantity for distinguishing between a prescribed reference person and a person in the registered image on the basis of the variation images generated from the registered image; a second variation image generation step for generating a plurality of variation images in which a prescribed variation is added to a match image that is the facial image being matched; a second image characteristic quantity extraction step for extracting a characteristic of the match image by calculating a prescribed characteristic quantity for distinguishing between a prescribed reference person and a person in the match image on the basis of the variation images generated from the match image; a first score computation step for calculating a first score (e.g. a match score S₁) that indicates a degree of agreement in a characteristic between the registered image and the match image; a second score computation step for calculating a second score (e.g., a match score S₂) that indicates a degree of agreement in a characteristic in a characteristic between the registered image and the match image on the basis of the extracted match image characteristic; and a match determination step for determining whether the person in the registered image and the person in the match image are the same person by a threshold determination using the calculated first score and the calculated second score.

The image characteristic extraction system of the present invention is an image characteristic extraction system for extracting a characteristic of a facial image that is used to match a facial image pattern, wherein the image characteristic extraction system is characterized in comprising variation image generation means (implemented by a variation image generation means 102, for example) for generating a plurality of variation images in which a prescribed variation is added to a facial image; and image characteristic quantity extraction means (implemented by a reference person comparison means 105, for example) for extracting a characteristic of a facial image being processed, by calculating a prescribed characteristic quantity for distinguishing between a person in the facial image being processed and a prescribed reference person on the basis of the variation images generated by the variation image generation means. The object of the present invention can be achieved by employing such a configuration as the one described above to determine whether the abovementioned people match.

The pattern matching system of the present invention is a pattern matching system for matching a facial image pattern on the basis of a facial image characteristic, wherein the pattern matching system is characterized in comprising variation image generation means for generating a plurality of variation images in which a prescribed variation is added to a facial image; and image characteristic quantity extraction means for extracting a characteristic of a facial image being processed, by calculating a prescribed characteristic quantity for distinguishing between a person in the facial image being processed and a prescribed reference person on the basis of the variation images generated by the variation image generation means. The object of the present invention can be achieved by employing such a configuration as the one described above to determine whether the abovementioned people match.

The pattern matching system may also comprise score computation means (implemented by a score computation means 301, for example) for comparing a characteristic of a registered image that is a pre-registered facial image, and of a match image that is a facial image being matched, and calculating a score that indicates a degree of agreement in the characteristic between the registered image and the match image on the basis of the facial image characteristic extracted by the image characteristic quantity extraction means; and match determination means (implemented by a match determination means 302, for example) for determining whether a person in the registered image and a person in the match image are the same person by comparing a prescribed threshold value with the score calculated by the score computation means.

A configuration may also be adopted in the pattern matching system wherein the match determination means determines whether the score calculated by the score computation means is larger than the prescribed threshold value, and determines that the person in the registered image and the person in the match image are the same person when a determination is made that the score is larger than the prescribed threshold value, and determines that the person in the registered image and the person in the match image are not the same person when a determination is made that the score is not larger than the prescribed threshold value.

The pattern matching system may also comprise characteristic information extraction means (implemented by a characteristic extraction means 103, for example) for extracting characteristic information (e.g., a frequency characteristic f) that indicates a characteristic of the variation images generated by the variation image generation means; and discriminant space projection means for projecting the characteristic information extracted by the characteristic information extraction means on a discriminant space that is obtained by linear discriminant analysis using a prescribed learning image (e.g., an image used for learning); wherein the image characteristic quantity extraction means calculates a prescribed characteristic quantity for distinguishing between a person in the facial image being processed and a prescribed reference person on the basis of the results of projection of the characteristic information on the discriminant space by the discriminant space projection means.

A configuration may also be adopted in the pattern matching system wherein the characteristic information extraction means extracts a frequency characteristic as characteristic information from the variation images generated by the variation image generation means.

The pattern matching system may also comprise learning image accumulation means (implemented by a learning image database, for example) for accumulating a prescribed learning image in advance, wherein the discriminant space projection means includes discriminant space computation means (implemented by a discriminant space projection means 104, for example) for calculating a discriminant space by linear discriminant analysis using the learning image accumulated by the learning image accumulation means; and projection means (implemented by the discriminant space projection means 104, for example) for projecting the characteristic information extracted by the characteristic information extraction means on the discriminant space calculated by the discriminant space computation means.

A configuration may be adopted in the pattern matching system wherein the variation image generation means generates as a variation image an image in which a facial orientation, a facial size, or a facial position of a person shown in a facial image is varied.

The pattern matching system may also comprise reference image accumulation means (implemented by a reference image database, for example) for accumulating in advance as reference person facial images an aggregate of facial images of people that have a distribution that resembles the face of the person in the facial image being processed, wherein the image characteristic quantity accumulation means calculates a characteristic quantity for distinguishing between the person in the facial image being processed and the reference person on the basis of the facial images accumulated by the reference image accumulation means.

A configuration may also be adopted in the pattern matching system wherein the image characteristic quantity extraction means calculates a prescribed discriminant vector and a prescribed parameter as characteristic quantities for distinguishing between the person in the facial image being processed and the reference person.

The pattern matching system may also be a pattern matching system for matching a pattern of a facial image on the basis of a facial image characteristic, wherein the pattern matching system comprises first variation image generation means (implemented by the variation image generation means 102, for example) for generating a plurality of variation images in which a prescribed variation is added to a registered image that is a pre-registered facial image; first image characteristic quantity extraction means (implemented by the reference person comparison means 105, for example) for extracting a characteristic of the registered image by calculating a prescribed characteristic quantity for distinguishing between a prescribed reference person and a person in the registered image on the basis of the variation images generated by the first variation image generation means; second variation image generation means (implemented by a variation image generation means 204, for example) for generating a plurality of variation images in which a prescribed variation is added to a match image that is the facial image being matched; second image characteristic quantity extraction means (implemented by a reference person comparison means 205, for example) for extracting a characteristic of the match image by calculating a prescribed characteristic quantity for distinguishing between a prescribed reference person and a person in the match image on the basis of the variation images generated by the second variation image generation means; first score computation means (implemented by a score computation means 301A, for example) for calculating a first score that indicates a degree of agreement in a characteristic between the registered image and the match image on the basis of a characteristic of the registered image that was extracted by the first image characteristic quantity extraction means; second score computation means (implemented by the score computation means 301A, for example) for calculating a second score that indicates a degree of agreement in a characteristic between the registered image and the match image on the basis of a characteristic of the match image that was extracted by the second image characteristic quantity extraction means; and match determination means (implemented by a match determination means 302A, for example) for determining whether the person in the registered image and the person in the match image are the same person by performing a threshold determination using the first score calculated by the first score computation means, and the second score calculated by the second score computation means.

The image characteristic extraction device of the present invention is an image characteristic extraction device (implemented by registered image accumulation servers 40, 40A, for example) for extracting a characteristic of a facial image that is used to match a facial image pattern, wherein the image characteristic extraction device is characterized in comprising variation image generation means for generating a plurality of variation images in which a prescribed variation is added to a facial image; and image characteristic quantity extraction means for extracting a characteristic of a facial image being processed, by calculating a prescribed characteristic quantity for distinguishing between a person in the facial image being processed and a prescribed reference person on the basis of the generated variation images. The object of the present invention can be achieved by employing such a configuration as the one described above to determine whether the abovementioned people match.

The image characteristic extraction program of the present invention is an image characteristic extraction program for extracting a characteristic of a facial image that is used to match a facial image pattern, wherein the image characteristic extraction program is characterized in causing a computer to execute a variation image generation routine for generating a plurality of variation images in which a prescribed variation is added to a facial image; and an image characteristic quantity extraction routine for extracting a characteristic of a facial image being processed, by calculating a prescribed characteristic quantity for distinguishing between a person in the facial image being processed and a prescribed reference person on the basis of the generated variation images. The object of the present invention can be achieved by employing such a configuration as the one described above to determine whether the abovementioned people match.

The pattern matching program of the present invention is a pattern matching program for matching a facial image pattern on the basis of a facial image characteristic, wherein the pattern matching program is characterized in causing a computer to execute a variation image generation routine for generating a plurality of variation images in which a prescribed variation is added to a facial image; an image characteristic quantity extraction routine for extracting a characteristic of a facial image being processed, by calculating a prescribed characteristic quantity for distinguishing between a person in the facial image being processed and a prescribed reference person on the basis of generated variation images; a score computation routine for comparing a characteristic of a registered image that is a pre-registered facial image, and of a facial image being matched, and calculating a score that indicates a degree of agreement in the characteristic between the registered image and the match image on the basis of the extracted facial image characteristic; and a match determination routine for determining whether a person in the registered image and a person in the match image are the same person by comparing the calculated score with a prescribed threshold value.

### EFFECTS OF THE INVENTION

According to the present invention, not only is characteristic extraction of a registered image performed using linear discriminant analysis, but a group of variation images for a facial image is also generated, and characteristic extraction is performed. A prescribed characteristic quantity for distinguishing between a reference person and the person in a facial image is calculated based on the generated group of variation images. The present invention enables a two-class distinction between the reference person and the person in the facial image by taking a variation component of the facial image into account. A facial image can be matched with high precision even when there is a variation specific to the registered person, by determining whether the person in the match image is the person in the registered image by performing two-class discriminant analysis of the reference person and the person in the facial image. Accordingly, highly precise identity matching using a facial image can be performed by taking into account the posture, illumination, and other variation components for each registered person.

A configuration is adopted in the present invention wherein a discriminant space is generated using variation images in addition to learning images when the discriminant space projection means generates a discriminant space, and the number of learning patterns can thereby be increased relative to a facial matching algorithm that uses the conventional linear discriminant analysis method. The discriminant capability during facial image matching can therefore be improved.

A configuration is adopted in the present invention wherein a group of variation images for a registered image is generated, as well as a group of variation images for a match image, and a characteristic quantity for distinguishing between a reference person and the person in the registered image is calculated, as well as a characteristic quantity for distinguishing between the reference person and the person in the match image. An average match score in which a plurality of match scores is averaged can thereby be calculated. Therefore, since a match can be determined based on an average match score in which a plurality of match scores is averaged, highly precise identity matching can be performed using a facial image.

### BRIEF DESCRIPTION OF THE DRAWINGS

FIG. 1 is a block diagram showing an example of the structure of the pattern matching system according to the present invention;

FIG. 2 is a flow diagram showing an example of the registered image processing whereby the pattern matching system calculates a characteristic of a registered image that is registered in advance;

FIG. 3 is a flow diagram showing an example of the match image processing whereby the pattern matching system calculates a characteristic of the match image;

FIG. 4 is a flow diagram showing an example of the identity determination routine whereby the pattern matching system determines whether the person being authenticated is the pre-registered person;

FIG. 5 is a diagram showing the relationship between the reference face space and the registered-person face space;

FIG. 6 is a block diagram showing an example of another structure of the pattern matching system;

FIG. 7 is a flow diagram showing another example of the match image processing whereby the pattern matching system calculates a characteristic of the match image;

FIG. 8 is a flow diagram showing another example of the identity determination processing whereby the pattern matching system determines whether the person being authenticated is the pre-registered person;

FIG. 9 is a block diagram showing an specific example of the structure of the pattern matching system; and

FIG. 10 is a block diagram showing another specific example of the structure of the pattern matching system.

### KEY

10: pattern matching system
100: registered image accumulation means
101: image normalization means
102: variation image generation means
103: characteristic extraction means
104: discriminant space projection means
105: reference person comparison means
200: match image input means
201: image normalization means
202: characteristic extraction means
203: discriminant space projection means
301: score computation means
302: match determination means

### BEST MODE FOR CARRYING OUT THE INVENTION

### Embodiment 1

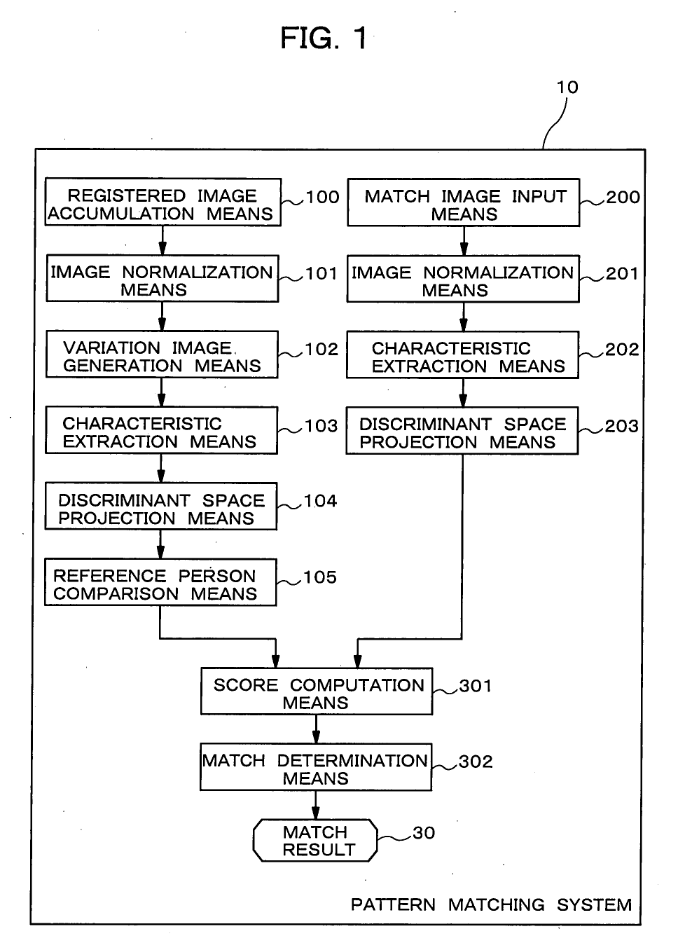

Embodiment 1 of the present invention will be described hereinafter with reference to the drawings. FIG. 1 is a block diagram showing an example of the structure of the pattern matching system according to the present invention for matching a pattern among two-dimensional facial images. As shown in FIG. 1, the pattern matching system 10 includes a registered image accumulation means 100, a match image input means 200, image normalization means 101, 201, a variation image generation means 102, characteristic extraction means 103, 202, discriminant space projection means 104, 203, a reference person comparison means 105, a score computation means 301, and a match determination means 302.

The pattern matching system 10 is specifically implemented using one or a plurality of workstations, personal computers, or other information processing devices. The pattern matching system 10 is applied to an entrance/exit management system, a system that uses access control, or another security system. For example, the pattern matching system 10 is used in an application of a same-person determination system (device) for determining whether the persons shown in two facial images are the same person when person authentication is performed in a security system.

The registered image accumulation means 100 is specifically implemented by a magnetic disk device, an optical disk device, or other database device. The registered image accumulation means 100 accumulates facial images (registered images) in advance of persons who may be subjects of authentication. In the present embodiment, registered images are accumulated in the registered image accumulation means 100 in advance by a registration operation performed by the operator of the pattern matching system 10, for example. The registered image accumulation means 100 may have a plurality of registered images accumulated in advance therein.

The image normalization means 101 is specifically implemented by the CPU of an information processing device that operates according to a program. The image normalization means 101 is provided with a function for normalizing the registered images. In the present embodiment, the image normalization means 101 extracts the registered images from the registered image accumulation means 100. The image normalization means 101 detects the positions of both eyes in an extracted facial image (registered image). The image normalization means 101 uses the acquired (detected) eye position information or the like to perform an affine transformation for the registered image so that the eye positions coincide with predetermined positions, and normalizes the face size and position. The image normalization means 101 is provided with a function for outputting the normalized facial image (also referred to as a normalized image) to the variation image generation means 102.

The variation image generation means 102 is specifically implemented by the CPU of an information processing device that operates according to a program. The variation image generation means 102 is provided with a function for generating a plurality of variation images in which a prescribed variation is added to a registered image. In the present embodiment, the normalized registered image from the image normalization means 101 is inputted to the variation image generation means 102. The variation image generation means 102 performs a prescribed conversion of an inputted normalized image and generates a plurality (30 images, for example) of variation images in which the facial orientation, the face size, and the facial position of the person in the registered image are varied.

For example, the pattern matching system 10 is provided with a shape model database (not shown) for accumulating standard facial shape models (e.g., shape models in which the faces of a plurality of people are averaged) in advance, characteristic calculated from the reference person with the discriminant characteristic (discriminant characteristic matrix T′) calculated from the registered image, and calculates an axis on the discriminant space having the highest discriminance between the registered person and the reference person. First, the reference person comparison means 105 calculates a covariance matrix S_{W1} within the discriminant characteristic space (discriminant space on which the discriminant characteristic is projected) for the registered person using Equation 6 below.

$${S}_{W 1} = \frac{1}{M} {\sum }_{i = 1}^{M} ( {T}_{i}^{′} - {\overline{T}}^{′} ) {( {T}_{i}^{′} - {\overline{T}}^{′} )}^{t} \qquad [ Equation 6 ]$$

In Equation 6, T′ᵢ indicates the i^{th} column vector of the discriminant characteristic matrix T′, and bar-T′ is the average vector of the column vectors of the discriminant characteristic matrix T′.

The reference person comparison means 105 then calculates a covariance matrix for the reference person. For example, the pattern matching system 10 is provided with a reference image database (not shown) for accumulating facial images of a reference person in advance. When a facial image of an adult male, for example, is registered as the registered image in the registered image accumulation In this case, the variation image generation means 102 can generate a variation image in which the facial orientation is varied by fitting an inputted normalized image to an accumulated standard facial shape model, rotating the shape model in three-dimensional space, and projecting the shape model back onto a two-dimensional plane. The variation image generation means 102 can also generate a variation image in which the facial size or position is varied by enlarging, reducing, or translating the inputted normalized image.

The variation image generation means 102 is provided with a function for outputting the generated variation images to the characteristic extraction means 103. The variation image generation means 102 is also provided with a function for outputting a normalized image that has not yet been varied along with the variation images to the characteristic extraction means 103. The term “variation image group” will be used hereinafter to collectively refer to the normalized image and variation images outputted by the variation image generation means 102. Specifically, the variation image generation means 102 outputs a variation image group that includes the generated variation images and the inputted normalized image to the characteristic extraction means 103.

The characteristic extraction means 103 is specifically implemented by the CPU of an information processing device that operates according to a program. The characteristic extraction means 103 is provided with a function for extracting characteristic information that indicates a characteristic of the variation images on the basis of the variation image group inputted from the variation image generation means 102. In the present embodiment, the variation image group outputted from the variation image generation means 102 is inputted to the characteristic extraction means 103. The characteristic extraction means 103 extracts a frequency characteristic as characteristic information on the basis of the inputted variation image group, and outputs the frequency characteristic to the discriminant space projection means 104. The term “frequency characteristic” refers to image characteristic information that is obtained by extracting a frequency component from an image. In the present embodiment, the characteristic extraction means 103 extracts a frequency characteristic for each of the normalized image and the variation images that are included in the variation image group.

In the present embodiment, the characteristic extraction means 103 extracts a frequency characteristic f by a calculation using Equation 2 below and the Gabor filter shown in Equation 1 below, on the basis of a variation image luminance I (x, y) that indicates the luminance of a variation image.

$$\begin{matrix}g ( x , y ) = \frac{1}{\sqrt{2 π σ}} exp ( - \frac{{x}^{2} + {y}^{2}}{2 {σ}^{2}} + i ( {k}_{x} x + {k}_{y} y ) ) & [ Equation 1 ] \\ f = {\sum }_{x} {\sum }_{y} g ( x - {x}_{0} , y - {y}_{0} ) I ( x , y ) & [ Equation 2 ]\end{matrix}$$

In Equations 1 and 2, kₓ, k_{y}, s, x₀, and y₀ are arbitrary parameters. The characteristic extraction means 103 extracts M characteristics from a variation image for each variation image (including the normalized image) included in the variation image group by varying the values of the parameters. When the number of variation images in the variation image group is designated as N, the characteristic extraction means 103 outputs a matrix T having M lines and N columns as characteristic information to the discriminant space projection means 104.

The discriminant space projection means 104 is specifically implemented by the CPU of an information processing device that operates according to a program. The discriminant space projection means 104 is provided with a function for projecting the characteristic information (characteristic of the variation image group of a registered image) inputted from the characteristic extraction means 103 onto a discriminant space that is calculated by linear discriminant analysis using a prescribed learning image. The discriminant space projection means 104 is also provided with a function for outputting information that indicates the results of projecting the characteristic of the variation image group of the registered image onto the discriminant space to the reference person comparison means 105. The “discriminant space” is a space onto which a characteristic of a facial image is mapped to facilitate personal identification.

In the present embodiment, the frequency characteristic outputted from the characteristic extraction means 103 is inputted to the discriminant space projection means 104. The discriminant space projection means 104 outputs the results of projecting the inputted frequency characteristic onto an L-dimensional discriminant space. In this case, the discriminant space projection means 104 uses linear discriminant analysis to generate the discriminant space.

The method whereby the discriminant space projection means 104 generates the discriminant space will next be described. For example, a match result 30 is provided with a learning image database (not shown) for accumulating a plurality of learning facial images in advance that are facial images for learning a discriminant space. The discriminant space projection means 104 inputs (extracts) a facial image for learning (learning facial image) from the learning image database. The discriminant space projection means 104 uses the image normalization means 101, the variation image generation means 102, and the characteristic extraction means 103 to calculate a characteristic matrix Tᵢ that indicates a characteristic of a learning facial image for each learning facial image. The subscript i indicates a learning facial image number (e.g., a number that is pre-assigned to each learning facial image)

When the characteristic matrix Tᵢ for all of the learning facial images is calculated, the discriminant space projection means 104 calculates an intra-class covariance matrix SW and an inter-class covariance matrix S_{b} on the basis of the calculated characteristic matrix Tᵢ. In this case the discriminant space projection means 104 uses Equation 3 below to calculate the intra-class covariance matrix S_{W}. The discriminant space projection means 104 uses Equation 4 below to calculate the inter-class covariance matrix S_{b}.

$$\begin{matrix}{S}_{W} = \frac{1}{N} {\sum }_{ij} {\sum }_{{T}_{ij} ∈ {R}_{k}} ( {T}_{ij} - {z}_{k} ) {( {T}_{ij} - {z}_{k} )}^{t} & [ Equation 3 ] \\ {S}_{b} = \frac{1}{n} {\sum }_{k} {n}_{k} ( {z}_{k} - z ) {( {z}_{k} - z )}^{t} & [ Equation 4 ]\end{matrix}$$

In Equations 3 and 4, Tᵢⱼ indicates the j^{th} column vector of the characteristic matrix Tᵢ, and Rₖ indicates the k^{th} class. The term zₖ indicates the average of the characteristic vector Tᵢⱼ in the k^{th} class, and z indicates the average of the characteristic vector in all the classes. The term nₖ indicates the number of characteristic vectors that belong to the k^{th} class, and n is the total number of characteristic vectors. In Equations 3 and 4, t indicates a vector transposition. In the equations hereinafter, t indicates the transposition of a vector or a matrix.

In the present embodiment, a single class is allocated for each person. For example, a single class is allocated for each person in the registered images that are registered in advance in the registered image accumulation means 100. In this case, the intra-class covariance matrix S_{W} calculated by the discriminant space projection means 104 indicates the size of the variation in the facial orientation or lighting conditions for the same person. The inter-class covariance matrix S_{b} indicates the size of the variation in the facial orientation or lighting conditions among different people.

The discriminant space projection means 104 calculates a matrix (S_{W})⁻¹S_{b} in which the inter-class covariance matrix S_{b} is multiplied by the inverse of the intra-class covariance matrix S_{W}. The discriminant space projection means 104 calculates an eigenvalue and an eigenvector for the calculated matrix (S_{W})⁻¹S_{b}. The discriminant space projection means 104 herein calculates L eigenvalues and eigenvectors for the matrix (S_{W})⁻¹S_{b}.

The discriminant space projection means 104 calculates a matrix V in which the L eigenvectors are arranged in the order of the largest eigenvalue for the matrix (S_{W})⁻¹S_{b}. The matrix V is an M-line L-column matrix. The matrix V that is calculated by the discriminant space projection means 104 will be referred to hereinafter as the discriminant matrix. The discriminant space projection means 104 calculates a matrix T′ using Equation 5 below by multiplying the matrix T inputted from the characteristic extraction means 103 by the discriminant matrix V (calculating the product of the matrix T and the discriminant matrix V).

T′=V′T [Equation 5]

In the present embodiment, the discriminant space projection means 104 calculates the matrix T′ shown in Equation 5 as information indicating the results of projecting the characteristic of the registered image onto an L-dimensional discriminant space. The matrix T′ calculated as result information by the discriminant space projection means 104 is also referred to hereinafter as a discriminant characteristic matrix. The discriminant space projection means 104 outputs the value of the calculated discriminant characteristic matrix T′ to the reference person comparison means 105.

The method described above for generating the discriminant space is described in “R. O. Duda, P. E. Hart, and D. G. Stork (authors), and M. Onoe (translation supervisor), “Pattern Recognition,” New Technology Communications, pp. 114-121 (Reference A).”

The reference person comparison means 105 is specifically implemented by the CPU of an information processing device that operates according to a program. The reference person comparison means 105 is provided with a function for calculating a prescribed characteristic quantity for distinguishing with high precision between a prescribed reference person and the person (also referred to as the registered person) in the registered image on the basis of the results of projection of the characteristic information onto the discriminant space by the discriminant space projection means 104. The term “reference person” refers to an aggregate of people that have a distribution that resembles the face (face of the registered person) that is retained for registration.

In the present embodiment, the reference person comparison means 105 compares the discriminant means 100, the pattern matching system 10 accumulates a plurality of adult-male facial images as facial images of a reference person. In this case, the reference person comparison means 105 calculates a covariance matrix for the reference person on the basis of the facial images of the reference person that are accumulated by the reference image database.

When the reference person is assumed to be an average person in the learning images, the reference person comparison means 105 calculates a covariance matrix S_{W2} for the reference person using Equation 7 below.

S_{W2}=V^{t}S_{W}V^{t} [Equation 7]

The reference person comparison means 105 uses Equation 8 below to calculate an optimum axis u in the discriminant space in order to identify a two-class pattern distribution of the registered person and the reference person from the person being matched, according to a linear discriminant analysis method.

u=(S_{W1}+S_{W2})⁻¹( T̅′−z) [Equation 8]

In Equation 8, z is the average of the characteristic vectors in all classes.

The reference person comparison means 105 then calculates the values of two prescribed parameters a, b using the calculated discriminant vector u. In this case, the reference person comparison means 105 calculates the prescribed vector a using Equation 9 below. The reference person comparison means 105 also calculates the prescribed vector b using Equation 10 below.

a=0.5×u^{t}( T̅′+z) [Equation 9]

b=0.5×u^{t}( T̅′−z) [Equation 10]

The values of the two parameters a, b calculated using Equations 9 and 10 are necessary when the score computation means 301 calculates the prescribed match score between the image for registration and the image for inputting. The reference person comparison means 105 outputs the calculated L-dimensional discriminant vector u and the values of the parameters a, b to the score computation means 301.

The match image input means 200 is specifically implemented by the CPU and an input/output interface unit of an information processing device that operates according to a program. The match image input means 200 is provided with a function for inputting the input facial image (referred to as the match image) that is being matched. For example, the information processing device that implements the pattern matching system 10 is provided with a camera or other image capture means. In this case, the image capture means of the match image input means 200 inputs the captured facial image as the match image in accordance with an operating instruction issued by the user. The match image input means 200 is provided with a function for outputting the inputted match image to an image normalization means 201.

The image normalization means 201 is specifically implemented by the CPU of an information processing device that operates according to a program. The image normalization means 201 is provided with a function whereby a match image is inputted from the match image input means 200. The image normalization means 201 is also provided with a function for normalizing the match image according to the same processing performed by the image normalization means 101. The image normalization means 201 is also provided with a function for outputting the normalized match image to the characteristic extraction means 202.

The characteristic extraction means 202 is specifically implemented by the CPU of an information processing device that operates according to a program. The characteristic extraction means 202 is provided with a function whereby the normalized match image is inputted from the image normalization means 201. The characteristic extraction means 202 is also provided with a function for extracting characteristic information that indicates a characteristic of the match image according to the same characteristic extraction processing performed by the characteristic extraction means 103. The characteristic extraction means 202 is also provided with a function for outputting the extracted characteristic information of the match image to the discriminant space projection means 203.

The characteristic extraction means 202 extracts characteristic information of a single image on the basis of the match image, unlike the characteristic extraction means 103, which extracts characteristic information of a plurality of images on the basis of a variation image group.

The discriminant space projection means 203 is specifically implemented by the CPU of an information processing device that operates according to a program. The discriminant space projection means 203 is provided with a function whereby the characteristic information of the match image is inputted from the characteristic extraction means 202. The discriminant space projection means 203 is also provided with a function for projecting a characteristic of the match image onto the discriminant space according to the same processing as the discriminant space projection means 104. The discriminant space projection means 203 is also provided with a function for outputting information that indicates the results of projecting the characteristic of the match image onto the discriminant space to the score computation means 301.

The discriminant space projection means 203 performs processing based on a single image (match image), unlike the discriminant space projection means 104, which executes processing based on a variation image group that includes a plurality of images. The discriminant space projection means 203 therefore generates a discriminant characteristic vector R as the information that indicates the results of projecting the characteristic of the match image in the L-dimensional discriminant space, and outputs the discriminant characteristic vector R to the score computation means 301.

The score computation means 301 is specifically implemented by the CPU of an information processing device that operates according to a program. The score computation means 301 is provided with a function for matching (comparing) a characteristic of the registered image and the match image to calculate a match score that indicates the degree of agreement in the characteristic between the registered image and the match image. The score computation means 301 is also provided with a function for outputting the calculated match score to the match determination means 302.

In the present embodiment, the values of the parameters a, b and the discriminant vector u calculated from the image for registration (registered image) are inputted to the score computation means 301 from the reference person comparison means 105. The discriminant characteristic vector R calculated from the match image is also inputted to the score computation means 301 from the discriminant space projection means 203. The score computation means 301 then computes the match score using the inputted discriminant vector u, the parameters a, b, and the discriminant characteristic vector R. In this case, the score computation means 301 computes, the match score S₁ using Equation 11 below.

S₁=(u^{t}R−a)/b [Equation 11]

According to the definitional equations for the parameters a, b shown in Equations 9 and 10, respectively, it is apparent that the match score S₁ is 1 when R=bar-T′ (i.e., when the discriminant characteristics of the registered image and the match image are equal). It is also apparent that the match score S₁ is −1 when R=z (i.e., when the discriminant characteristic of the match image and the discriminant characteristic of the reference person are equal). The score computation means 301 outputs the calculated match score S₁ to the match determination means 302.

The match determination means 302 is specifically implemented by the CPU of an information processing device that operates according to a program. The match determination means 302 is provided with a function for determining whether the person in the registered image and the person in the match image are the same person by comparing the match score with a prescribed threshold value. The match determination means 302 is also provided with a function for outputting the match result 30 that indicates whether the abovementioned people are the same.

The match score that was calculated by the score computation means 301 is inputted to the match determination means 302. The match determination means 302 uses the inputted match score to determine whether the person in the registered image and the person in the match image are the same person. In this case, the match determination means 302 determines whether the inputted match score S₁ is larger than the prescribed threshold value t. When the match score S₁ is determined to be larger than the threshold value t, the match determination means 302 determines that the person in the match image is same as the person being matched (i.e., the person in the registered image and the person in the match image are the same person). When the match score S₁ is determined not to be larger than the threshold value t (e.g., the match score S₁ is small), the match determination means 302 determines that the person in the match image is a person other than the person being matched (i.e., the person in the registered image and the person in the match image are not the same person).

The match determination means 302 also outputs the result (match result 30) of determining whether the person in the match image is the person being matched. For example, the match determination means 302 outputs the match result 30 to the entrance/exit management system or other security system. The match determination means 302 may also display the match result 30 in a display device or other displaying device, for example.

In the present embodiment, the storage device (not shown) of the information processing device that implements the pattern matching system 10 stores various types of programs for executing routines for extracting facial image characteristics. For example, the storage device of the information processing device stores an image characteristic extraction program for causing a computer to execute a variation image generation routine for generating a plurality of variation images in which a prescribed variation is added to a facial image; and an image characteristic quantity extraction routine for extracting a characteristic of a facial image being processed, by calculating a prescribed characteristic quantity for distinguishing between a person in the facial image being processed and a prescribed reference person on the basis of the generated variation images.

In the present embodiment, the storage device of the information processing device stores various types of programs for executing routines for matching a facial image pattern. For example, the storage device of the information processing device causes a computer to execute a variation image generation routine for generating a plurality of variation images in which a prescribed variation is added to a facial image; an image characteristic quantity extraction routine for extracting a characteristic of a facial image being processed, by calculating a prescribed characteristic quantity for distinguishing between a person in the facial image being processed and a prescribed reference person on the basis of generated variation images; a score computation routine for comparing a characteristic of a registered image that is a pre-registered facial image, and of a facial image being matched, and calculating a score that indicates a degree of agreement in the characteristic between the registered image and the match image on the basis of the extracted facial image characteristic; and a match determination routine for determining whether a person in the registered image and a person in the match image are the same person by comparing the calculated score with a prescribed threshold value.

The operation of the present embodiment will next be described. In the present embodiment, an example is described in which the pattern matching system 10 is applied to an entrance/exit management system, and identity authentication is performed for verifying whether a person entering a building is a pre-registered person. The pattern matching system 10 is not limited to an entrance/exit management system, and may also be used in a system that uses access control, or in another security system.

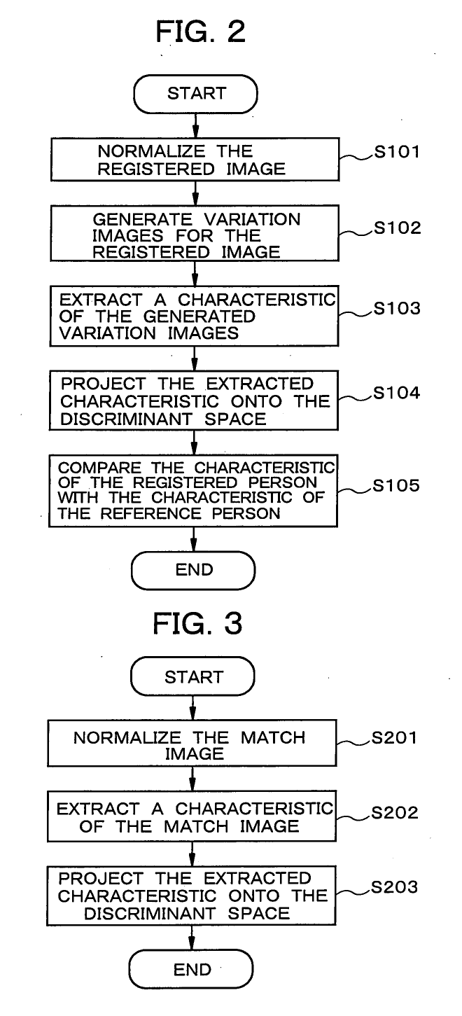

The operation whereby the pattern matching system 10 calculates a characteristic of a registered image that is registered in advance will next be described. FIG. 2 is a flow diagram showing an example of the registered image processing whereby the pattern matching system calculates a characteristic of a registered image that is registered in advance.

The image normalization means 101 extracts a registered image from the registered image accumulation means 100 at a prescribed time. For example, the image normalization means 101 extracts a registered image from the registered image accumulation means 100 when a building entry operation is performed by a user. The image normalization means 101 detects the position information for both eyes in the extracted registered image, and normalizes the registered image by transforming the facial size or position so that the eyes are in the predetermined positions (step S101). The image normalization means 101 outputs the normalized registered image to the variation image generation means 102.

The variation image generation means 102 generates a plurality of variation images for the registered image on the basis of the normalized image from the image normalization means 101 (step S102). In this case, the variation image generation means 102 generates a plurality of variation images in which the facial orientation, facial size, or facial position of the person in the registered image is varied. When the variation images are generated, the variation image generation means 102 outputs the variation image group to the characteristic extraction means 103.

The characteristic extraction means 103 extracts the characteristic information of the variation images (including the normalized image) that are included in the variation image group from the variation image generation means 102 (step S103). In this case, the characteristic extraction means 103 extracts a frequency characteristic of the variation images as characteristic information on the basis of the variation image group. The characteristic extraction means 103 outputs the extracted frequency characteristic to the discriminant space projection means 104.

The discriminant space projection means 104 projects onto the discriminant space the characteristic that was extracted from the variation image group of the registered image, on the basis of the frequency characteristic from the characteristic extraction means 103 (step S104). The discriminant space projection means 104 outputs information that indicates the results of projecting the characteristic of the variation image group of the registered image onto the discriminant space to the reference person comparison means 105. In this case, the discriminant space projection means 104 performs calculation using Equations 3 through 5 and outputs the discriminant characteristic matrix T′ as result information.

The reference person comparison means 105 compares the characteristic of the registered image with the characteristic of the reference person and calculates a prescribed characteristic quantity for distinguishing between the registered person and the reference person with high precision on the basis of the result information from the discriminant space projection means 104 (step S105). In this case, the reference person comparison means 105 performs calculation using Equations 6 through 8, and calculates a discriminant vector u as the characteristic quantity. The reference person comparison means 105 performs calculation using Equations 9 and 10, and calculates prescribed parameters a, b as the characteristic quantity. The reference person comparison means 105 then outputs the calculated characteristic quantities to the score computation means 301.

As described above, a characteristic of the registered image is extracted through the execution of the routines in steps S101 through S105. When a plurality of registered images is accumulated in the registered image accumulation means 100, the pattern matching system 10 may execute the routines from step S101 to step S105 for each of the registered images, and output the calculated characteristic quantities to the reference person comparison means 105.

A case was described in which the facial images of the reference person were used without modification to calculate the prescribed characteristic quantity, but the reference person comparison means 105 may also generate a plurality of variation images for each facial image of the reference person in step S105 according to the same processing as in step S102. In this case, the reference person comparison means 105 may execute a routine for projecting the characteristic of the generated variation image group of the reference person onto the discriminant space, and calculate the prescribed characteristic quantity (discriminant vector u or parameters a, b), according to the same processing as steps S103 and S104. The characteristic quantity of the registered image can thereby be appropriately calculated even when there is a small number of samples of facial images accumulated for the reference person, for example.

Instead of executing registered image processing at the time of an entry operation, the pattern matching system 10 may be configured so that a characteristic of the registered images that are registered in the registered image accumulation means 100 is extracted in advance and accumulated in a database. In this case, the pattern matching system 10 is provided with a characteristic quantity database, for example, for accumulating the characteristic quantity (discriminant vector u or parameters a, b) calculated by the reference person comparison means 105. The reference person comparison means 105 extracts a characteristic quantity from the characteristic quantity database and outputs the characteristic quantity to the score computation means 301 according to a request from the score computation means 301.

The operation whereby the pattern matching system 10 calculates a characteristic of the match image will next be described. FIG. 3 is a flow diagram showing an example of the match image processing whereby the pattern matching system calculates a characteristic of the match image.

The match image input means 200 inputs the match image at the prescribed time. For example, when a user performs a building entry operation, the match image input means 200 causes a camera or other image capture means provided to the pattern matching system 10 to capture an image of the face of the user who performed the entry operation. The match image input means 200 then inputs the facial image captured by the image capture means as the match image.

The image normalization means 201 normalizes the match image from the match image input means 200 according to the same processing as the image normalization means 101 (step S201). The image normalization means 201 outputs the normalized match image to the characteristic extraction means 202.

When the normalized match image is inputted from the image normalization means 201, the characteristic extraction means 202 extracts the characteristic information (frequency characteristic) of the match image according to the same processing as the variation image generation means 102 (step S202). The characteristic extraction means 202 outputs the extracted frequency characteristic to the discriminant space projection means 203.

The discriminant space projection means 203 projects the characteristic extracted from the match image onto the discriminant space according to the same processing as the discriminant space projection means 104 on the basis of the frequency characteristic from the characteristic extraction means 202 (step S203). The discriminant space projection means 203 also outputs information that indicates the results of projecting the characteristic of the match image onto the discriminant space to the score computation means 301. In this case, the discriminant space projection means 203 outputs a discriminant characteristic vector R as the result information.

As described above, a characteristic of the match image is extracted through the execution of the routines in steps S201 through S203.

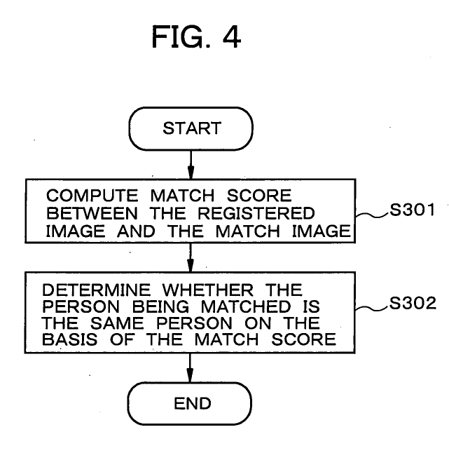

The operation whereby the pattern matching system 10 matches the characteristics of the registered image and the match image will next be described. FIG. 4 is a flow diagram showing an example of the identity determination routine whereby the pattern matching system matches the characteristics of the registered image and the match image to determine whether the person being authenticated is the pre-registered person.

The characteristic quantities (discriminant vector u or parameters a, b) of the registered image are inputted from the reference person comparison means 105 to the score computation means 301. The characteristic quantity (discriminant characteristic vector R) of the match image is inputted from the discriminant space projection means 203 to the score computation means 301. The score computation means 301 then matches the characteristics of the registered image and the match image to calculate the match score between the registered image and the match image on the basis of the inputted characteristic quantities (step S301). In this case, the score computation means 301 calculates the match score S₁ through a calculation using Equation 11. The score computation means 301 outputs the calculated match score to the match determination means 302.

The match determination means 302 determines whether the person being matched is the pre-registered person on the basis of the match score calculated by the score computation means 301 (step S302). In this case, the match determination means 302 determines whether the match score S₁ is larger than the prescribed threshold value t, and determines that the person in the match image is the pre-registered person when the match score S₁ is larger than the threshold value t. When the match score S₁ is determined to be smaller than the threshold value t, the match determination means 302 determines that the person in the match image is not the pre-registered person.

When the identity determination is performed, the match determination means 302 outputs the result (match result 30) of determining whether the person being matched is the pre-registered person. The entrance/exit management system allows or prohibits passage of the user who performed the entry operation on the basis of the match result 30 of the match determination means 302. In this case, when the match determination means 302 determines that the person being matched is the registered person, the entrance/exit management system opens a flapper gate, for example, to allow the user to pass through. When the match determination means 302 determines that the person being matched is not the registered person, the entrance/exit management system leaves the flapper gate closed, for example, to prevent the user from passing.

When a plurality of registered images is registered in the registered image accumulation means 100, the characteristic quantities for the registered images may be inputted to the score computation means 301 from the reference person comparison means 105. In this case, the match determination means 302 determines for each registered image whether the person in the match image is the pre-registered person. When the person in the match image is determined to be the person in any of the registered images, the match determination means 302 determines that the person being matched is the registered person. When the person in the match image is determined not to match the person in any of the registered images, the match determination means 302 determines that the person being matched is not the registered person.

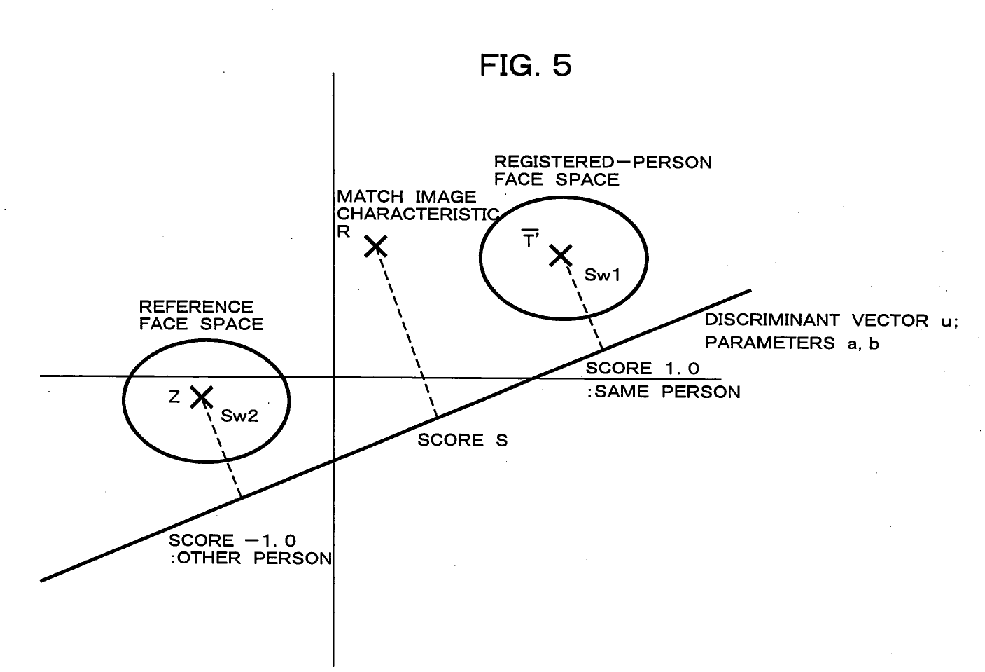

FIG. 5 is a diagram showing the relationship between the reference face space and the registered-person face space. In FIG. 5, bar-T′ is the average vector in the registered-person face space. S_{W1} is the covariance matrix in the registered-person face space, z is the average vector in the reference face space, and S_{W2} is the covariance matrix in the reference face space.

In FIG. 5, the vector u is the discriminant vector for discriminating between the registered person and the reference person, and is directed by the reference person comparison means 105 using Equation 8. The registered image characteristics (discriminant vector u and parameters a, b) are calculated by the reference person comparison means 105. The match image characteristic (discriminant characteristic vector R) is calculated by the discriminant space projection means 203.

Match scores are calculated by the score computation means 301 from the registered image characteristics u, a, b and the discriminant characteristic vector R as values when the discriminant characteristic vector R is projected on the discriminant vector u, as shown in FIG. 5.

As shown in FIG. 5, the match score S₁ is 1 when the discriminant characteristics of the registered image and the match image are equal (i.e., when R=bar-T′). The match score S₁ is −1 when the discriminant characteristic of the match image and the discriminant characteristic of the reference person are equal (i.e., when R=z). Accordingly, it is apparent that the person in the match image approaches the person in the registered image the closer the value of the match score S₁ is to 1. It is also apparent that the person in the match image approaches the reference person (i.e., a person other than the registered person) the closer the value of the match score S₁ is to −1.

According to the present embodiment as described above, a characteristic is extracted from a registered image using linear discriminant analysis, and a characteristic is also extracted from a group of variation images generated for the registered image. A prescribed characteristic quantity is also calculated for distinguishing between a reference person and the person in the registered image on the basis of the generated variation image group. A two-class discriminant analysis of the reference person and the person in the registered image is also performed, whereby a determination is made as to whether the person in the match image is the person in the registered image. The present embodiment enables a two-class distinction between the reference person and the person in the registered image by taking a variation component of the registered image into account. Therefore, highly precise facial image matching can be performed even when there is a variation that is specific to the registered person. An identity can thus be matched with high precision using a facial image by taking posture, illumination, and other variation components into account for each registered person.

For example, a case will be considered in which the variation image generation means 102 is not included as a constituent element of the pattern matching system 10 shown in FIG. 1. In this case, since a variation image group for the registered image cannot be generated, the reference person comparison means 105 can no longer generate the covariance matrix in the discriminant characteristic for registration. Therefore, the pattern matching system 10 cannot perform facial image matching that takes variation components of the registered image into account. Specifically, in the present embodiment, the provision of the variation image generation means 102 and the reference person comparison means 105 is an essential condition for enabling facial image matching that takes variation components of the registered image into account.

According to the present embodiment, variation images are used in addition to learning images to generate the discriminant space when the discriminant space used by the discriminant space projection means 104 is generated. The number of learning patterns is therefore increased relative to a facial matching algorithm that uses the conventional linear discriminant analysis method. Increased discriminant performance can therefore be anticipated.

### Embodiment 2

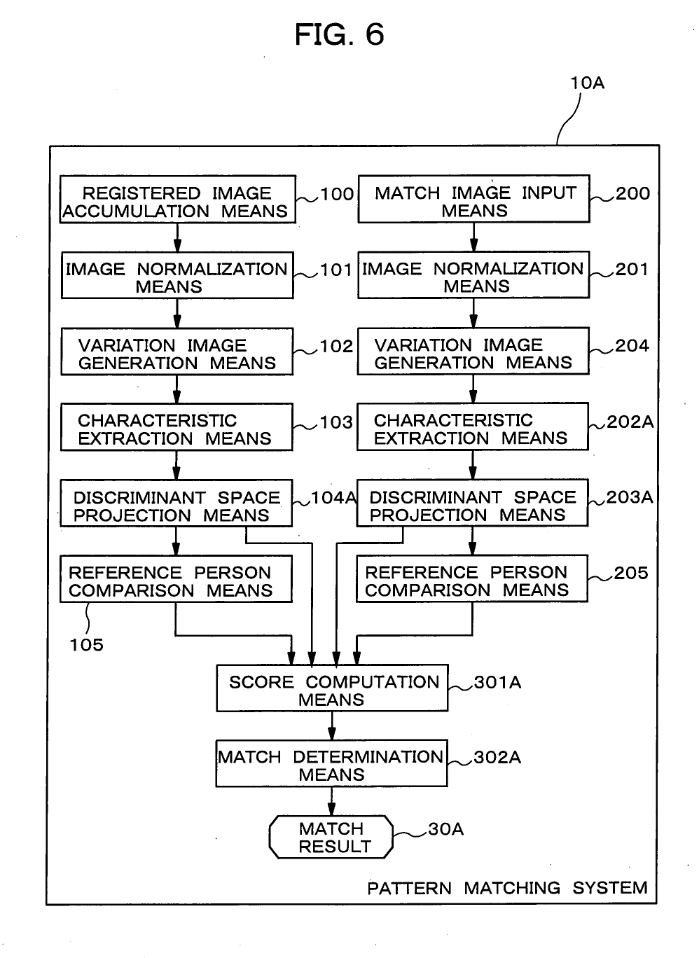

Embodiment 2 of the present invention will next be described with reference to the drawings. FIG. 6 is a block diagram showing an example of another structure of the pattern matching system. As shown in FIG. 6, the pattern matching system 10A in the present embodiment includes the variation image generation means 204 and the reference person comparison means 205 in addition to the constituent elements described in Embodiment 1. In the present embodiment, the functions of the discriminant space projection means 104A, the characteristic extraction means 202A, the discriminant space projection means 203A, the score computation means 301A, and the match determination means 302A differ from the functions of the same components in Embodiment 1.

The functions of the registered image accumulation means 100, the image normalization means 101, the variation image generation means 102, the characteristic extraction means 103, the reference person comparison means 105, the match image input means 200, and the image normalization means 201 are the same as the functions of the same components in Embodiment 1.

The discriminant space projection means 104A is provided with a function for projecting a characteristic of the variation image group of the registered image onto the discriminant space on the basis of the characteristic information inputted from the characteristic extraction means 103, in the same manner as the discriminant space projection means 104 described in Embodiment 1. The discriminant space projection means 104A is also provided with a function for outputting information that indicates the results of projecting the characteristic of the variation image group of the registered image onto the discriminant space to the reference person comparison means 105.

In addition to the functions of the discriminant space projection means 104 described in Embodiment 1, the discriminant space projection means 104A is provided with a function for projecting a characteristic solely of the registered image onto the discriminant space and outputting the information that indicates the results of projecting the characteristic of the registered image onto the discriminant space to the score computation means 301A. In the present embodiment, the discriminant space projection means 104A generates a discriminant characteristic vector R′ as the result information and outputs the discriminant characteristic vector R′ to the score computation means 301A according to the same processing as the discriminant space projection means 203 described in Embodiment 1.

The variation image generation means 204 is specifically implemented by the CPU of an information processing device that operates according to a program. The variation image generation means 204 is provided with a function whereby the normalized match image is inputted from the image normalization means 201. The variation image generation means 204 is also provided with a function for generating a plurality of variation images in which a prescribed variation is added to the normalized match image according to the same processing as the variation image generation means 102. The variation image generation means 204 is also provided with a function for inputting the generated variation image group to the characteristic extraction means 202A.

The characteristic extraction means 202A is provided with a function for extracting characteristic information (e.g., a frequency characteristic) that indicates a characteristic of the variation images on the basis of the variation image group that is inputted from the variation image generation means 204, according to the same processing as the characteristic extraction means 103. The characteristic extraction means 202A is also provided with a function for outputting the extracted characteristic information to the discriminant space projection means 203A.

The discriminant space projection means 203A is provided with a function whereby the characteristic information of the match image is inputted from the characteristic extraction means 202, and the characteristic of the match image is projected onto the discriminant space, in the same manner as in the discriminant space projection means 203 described in Embodiment 1. The discriminant space projection means 203A is also provided with a function for outputting the information that indicates the results of projecting the characteristic of the match image onto the discriminant space to the score computation means 301A.

In addition to the functions of the discriminant space projection means 203 described in Embodiment 1, the discriminant space projection means 203A is provided with a function for projecting the characteristic of the variation image group of the match image onto the discriminant space on the basis of the characteristic information inputted from the characteristic extraction means 202A, according to the same processing as the discriminant space projection means 104A. The discriminant space projection means 203A is also provided with a function for outputting the information that indicates the results of projecting the characteristic of the variation image group of the match image onto the discriminant space to the reference person comparison means 205, according to the same processing as the discriminant space projection means 104A.

The reference person comparison means 205 is specifically implemented by the CPU of an information processing device that operates according to a program. The reference person comparison means 205 is provided with a function for calculating a prescribed characteristic quantity for distinguishing between the person in the match image and the prescribed reference person with high precision according to the same processing as the reference person comparison means 105. In the present embodiment, the reference person comparison means 205 calculates a discriminant vector u′ and parameters a′, b′ as the prescribed characteristic quantities, according to the same processing as the reference person comparison means 105.

The score computation means 301A is provided with a function for matching a characteristic of the registered image and the match image to calculate a match score. The score computation means 301A is also provided with a function for outputting the calculated match score to the match determination means 302A.

In the present embodiment, the values of the discriminant vector u and the parameters a, b calculated from the registered image are inputted from the reference person comparison means 105 to the score computation means 301A, in the same manner as in the score computation means 301 described in Embodiment 1. The discriminant characteristic vector R calculated from the match image is inputted to the score computation means 301A from the discriminant space projection means 203A. The score computation means 301A calculates a match score (referred to as the first match score) using the inputted discriminant vector u, the parameters a, b, and the discriminant characteristic vector R. In this case, the score computation means 301A computes the first match score S₁ using Equation 11.

The values of the discriminant vector u′ and the parameters a′, b′ calculated from the match image are inputted from the reference person comparison means 205 to the score computation means 301A. The discriminant characteristic vector R′ calculated from the registered image is inputted to the score computation means 301A from the discriminant space projection means 104A. The score computation means 301A calculates a match score (referred to as the second match score) using the inputted discriminant vector u′, the parameters a′, b′, and the discriminant characteristic vector R′. In this case, the score computation means 301A computes the second match score S₂ using Equation 12 below.

S₂=(u′^{t}R′−a′)/b′ [Equation 12]

The score computation means 301A also calculates a match score (referred to as the average match score) S that is the average of the calculated first match score S₁ and second match score S₂. The score computation means 301A outputs the calculated average match score to the match determination means 302A.

The match determination means 302A is provided with a function for determining whether the person in the registered image and the person in the match image are the same person. The match determination means 302A is also provided with a function for outputting a match result 30A that indicates whether the person in the registered image and the person in the match image are the same person.

In the present embodiment, the average match score calculated by the score computation means 301 is inputted to the match determination means 302A. The match determination means 302A uses the inputted average match score to determine whether the person in the registered image and the person in the match image are the same person. In this case, the match determination means 302A determines whether the inputted average match score S is larger than a prescribed threshold value t. When the average match score S is determined to be larger than the threshold value t, the match determination means 302A determines that the person in the match image is the person being matched (i.e., the person in the registered image and the person in the match image are the same person). When the average match score S is determined not to be larger than the threshold value t, the match determination means 302A determines that the person in the match image is a person other than the person being matched (i.e., the person in the registered image and the person in the match image are not the same person).

The match determination means 302A outputs the result (match result 30A) of determining whether the person in the match image is the person being matched. For example, the match determination means 302A outputs the match result 30A to the entrance/exit management system or other security system. The match determination means 302A may also display the match result 30A in a display device or other displaying device, for example.

The operation of the present embodiment will next be described. The operation whereby the pattern matching system 10A calculates a characteristic of the registered image registered in advance will first be described. In the present embodiment, the pattern matching system 10A calculates a characteristic of the pre-registered registered image according to the same processing that is performed in steps S101 through S105 shown in FIG. 2. In step S104 in the present embodiment, the discriminant space projection means 104A projects the characteristic of the variation image group of the registered image onto the discriminant space, and also projects a characteristic solely of the registered image onto the discriminant space and outputs the discriminant characteristic vector R′ to the score computation means 301A.

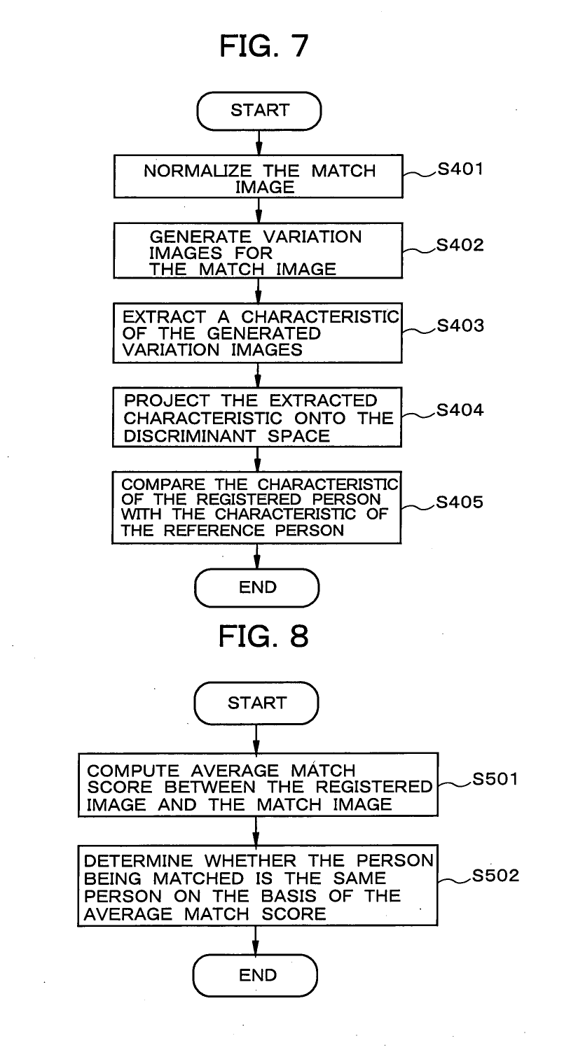

The operation whereby the pattern matching system 10A calculates a characteristic of the match image will next be described. FIG. 7 is a flow diagram showing another example of the match image processing whereby the pattern matching system calculates a characteristic of the match image. The match image input means 200 inputs the match image at the prescribed time. The image normalization means 201 normalizes the match image from the match image input means 200 according to the same processing in step S201 of FIG. 3 (step S401). The image normalization means 201 outputs the normalized match image to the variation image generation means 204.

The variation image generation means 204 generates a plurality of variation images for the match image on the basis of the normalized image from the image normalization means 201 (step S402). In this case, the variation image generation means 204 generates a plurality of facial images as variation images in which the facial orientation, facial size, or facial position of the person in the match image is varied. When the variation images are generated, the variation image generation means 204 outputs the variation image group to the characteristic extraction means 202A.

The characteristic extraction means 202A extracts the characteristic information of the variation images (including the normalized match image) included in the variation image group from the variation image generation means 204 (step S403). In this case, the characteristic extraction means 202A extracts the frequency characteristic of the variation images as characteristic information on the basis of the variation image group. The characteristic extraction means 202A outputs the extracted frequency characteristic to the discriminant space projection means 203A.

The discriminant space projection means 203A projects the characteristic that was extracted from the variation image group of the match image onto the discriminant space on the basis of the frequency characteristic from the characteristic extraction means 202A (step S404). The discriminant space projection means 203A outputs the information indicating the results of projecting the characteristic of the variation image group of the match image onto the discriminant space to the reference person comparison means 205. The discriminant space projection means 203A projects the characteristic of the variation image group of the match image onto the discriminant space, projects a characteristic solely of the match image onto the discriminant space, and outputs the discriminant characteristic vector R to the score computation means 301A.

The reference person comparison means 205 compares the characteristic of the person in the match image with the characteristic of the reference person and calculates a prescribed characteristic quantity for distinguishing between the person in the match image and the reference person with high precision, on the basis of the result information from the discriminant space projection means 203A (step S405). In this case, the reference person comparison means 205 performs calculation using Equations 6 through 8, and calculates a discriminant vector u′ as the characteristic quantity. The reference person comparison means 205 performs calculation using Equations 9 and 10, and calculates prescribed parameters a′, b′ as the characteristic quantity. The reference person comparison means 205 then outputs the calculated characteristic quantities to the score computation means 301A.

The operation whereby the pattern matching system 10A matches the characteristics of the registered image and the match image will next be described. FIG. 8 is a flow diagram showing another example of the identity determination processing whereby the pattern matching system matches the characteristics of the registered image and the match image to determine determines whether the person being authenticated is the pre-registered person.

The characteristic quantities (discriminant characteristic vector R′ or discriminant vector u, and parameters a, b) of the registered image are inputted from the discriminant space projection means 104A and the reference person comparison means 105 to the score computation means 301A. The characteristic quantities (discriminant characteristic vector R or discriminant vector u′, and parameters a′, b′) of the match image are inputted from the discriminant space projection means 203A and the reference person comparison means 205 to the score computation means 301A.

The score computation means 301A matches the characteristics of the registered image and the match image to calculate the average match score between the registered image and the match image on the basis of the inputted characteristic quantities (step S501). The score computation means 301A outputs the calculated average match score to the match determination means 302A.

The match determination means 302A determines whether the person being matched is the pre-registered person on the basis of the average match cote that was calculated by the score computation means 301A (step S502). In this case, the match determination means 302A determines whether the average match score S is larger than a prescribed threshold value t. When the average match score S is determined to be larger than the threshold value t, the match determination means 302A determines that the person in the match image is the pre-registered person. When the average match score S is determined not to be larger than the threshold value t, the match determination means 302A determines that the person in the match image is not the pre-registered person.

When the identity determination is performed, the match determination means 302A outputs the result (match result 30A) of determining whether the person being matched is the pre-registered person. The entrance/exit management system allows or prohibits passage of the user who performed the entry operation on the basis of the match result 30A of the match determination means 302A.

According to the present embodiment as described above, a variation image group is generated for the registered image, as well as for the match image. Not only is a characteristic quantity calculated for distinguishing between the person in the registered image and the reference person, but a characteristic quantity for distinguishing between the person in the match image and the reference person is calculated on the basis of the generated variation image group. A match score is calculated using the characteristic quantity for distinguishing between the reference person and the person in the registered image, and a match score is also calculated using the characteristic quantity for distinguishing between the reference person and the person in the match image. Facial image matching is performed based on the average match score of the two match scores. According to the present embodiment, since matching can be performed based on the average match score obtained by averaging a plurality of match scores, identity matching using facial images can be performed with higher precision.

### EXAMPLE 1

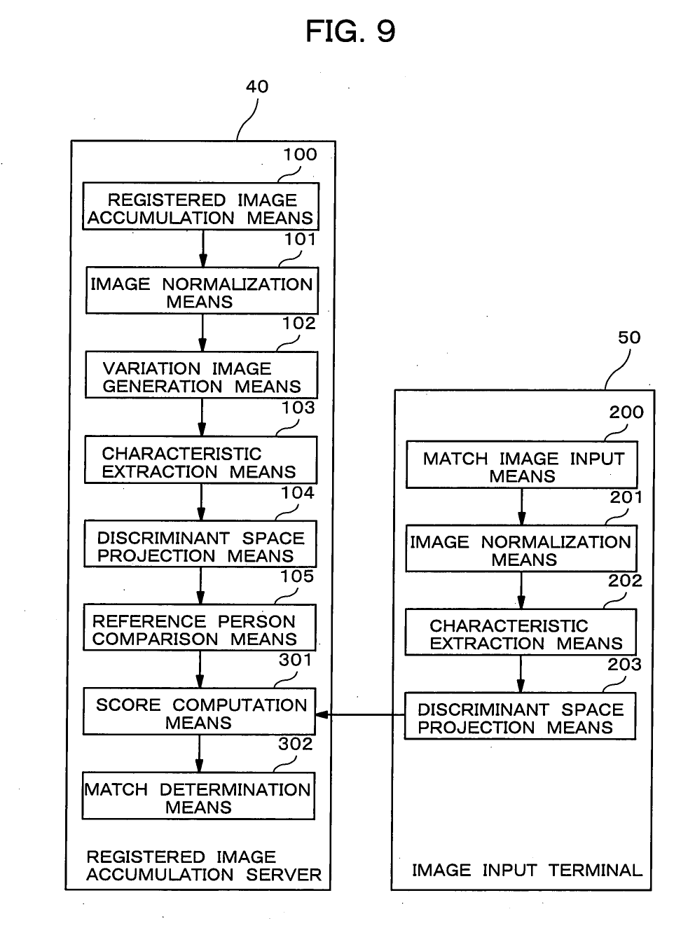

Example 1 of the present invention will next be described with reference to the drawings. The present example corresponds to a more specific description of the structure of the pattern matching system 10 described in Embodiment 1. FIG. 9 is a block diagram showing an specific example of the structure of the pattern matching system 10. As shown in FIG. 9, the pattern matching system 10 includes a registered image accumulation server 40 for accumulating a registered image in advance, and an image input terminal 50 for inputting a match image. The registered image accumulation server 40 and the image input terminal 50 are connected to each other via a LAN or other network. A single image input terminal 50 is shown in FIG. 9, but the pattern matching system 10 may include multiple image input terminals 50.

The registered image accumulation server 40 is specifically implemented by a workstation, personal computer, or other information processing device. As shown in FIG. 9, the registered image accumulation server 40 includes the registered image accumulation means 100, the image normalization means 101, the variation image generation means 102, the characteristic extraction means 103, the discriminant space projection means 104, the reference person comparison means 105, the score computation means 301, and the match determination means 302. The basic functions of the registered image accumulation means 100, the image normalization means 101, the variation image generation means 102, the characteristic extraction means 103, the discriminant space projection means 104, the reference person comparison means 105, the score computation means 301, and the match determination means 302 are the same as the functions of the same components described in Embodiment 1.

The image input terminal 50 is specifically implemented by a workstation, personal computer, or other information processing device. As shown in FIG. 9, the image input terminal 50 includes the match image input means 200, the image normalization means 201, the characteristic extraction means 202, and the discriminant space projection means 203. The basic functions of the match image input means 200, the image normalization means 201, the characteristic extraction means 202, and the discriminant space projection means 203 are the same as the functions of the same components described in Embodiment 1.

In the present example, the image input terminal 50 calculates a characteristic quantity of the inputted match image according to the match image processing shown in FIG. 3 when the match image input means 200 is used to input a match image. When the characteristic quantity of the match image is calculated, the discriminant space projection means 203 transmits the calculated characteristic quantity to the registered image accumulation server 40 via the network. In the present example, the discriminant space projection means 203 requests matching of the match image and the registered image from the registered image accumulation server 40 by transmitting the characteristic quantity of the match image.

The registered image accumulation server 40 calculates the characteristic quantity of the pre-registered registered image according to the registered image processing shown in FIG. 2 when the characteristic quantity of the match image is received. The registered image accumulation server 40 then determines whether the person in the match image is the registered person on the basis of the calculated characteristic quantity of the registered image, and the characteristic quantity of the match image that was received from the image input terminal 50, according to the identity determination processing shown in FIG. 4.

In the present example, the pattern matching system 10 was composed of the registered image accumulation server 40 and the image input terminal 50, but the pattern matching system 10 may also be composed of a single information processing device.

### EXAMPLE 2

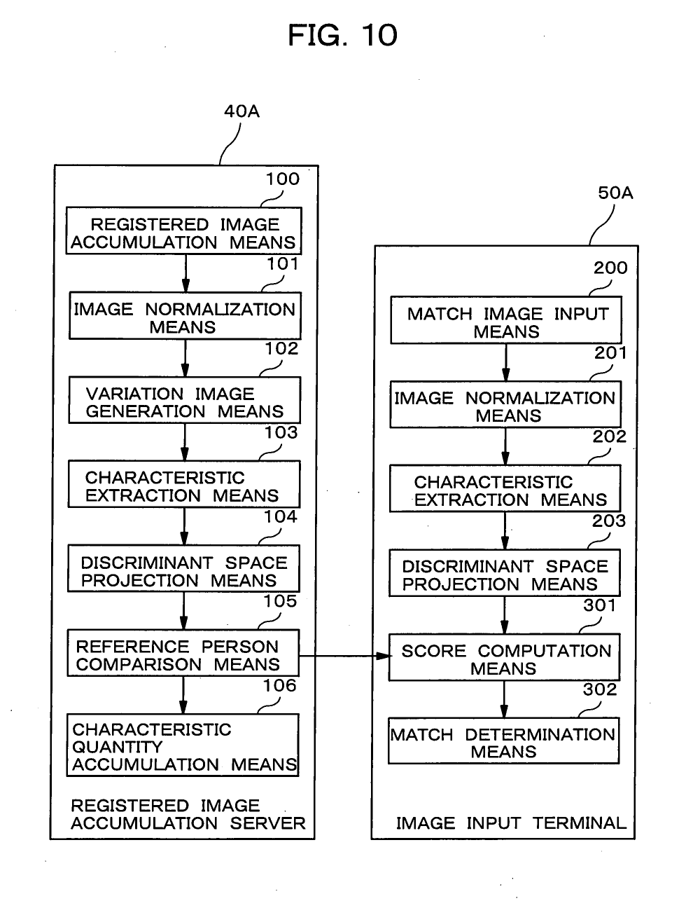

Example 2 of the present invention will next be described with reference to the drawings. Like Example 1, the present example corresponds to a more specific description of the structure of the pattern matching system 10 described in Embodiment 1. FIG. 10 is a block diagram showing another specific example of the structure of the pattern matching system 10. As shown in FIG. 10, the pattern matching system 10 includes a registered image accumulation server 40A for accumulating a registered image in advance, and a image input terminal 50A for inputting a match image. The registered image accumulation server 40A and the image input terminal 50A are also connected to each other via a LAN or other network. A single image input terminal 50A is shown in FIG. 10, but the pattern matching system 10 may also include multiple image input terminals 50A.

The registered image accumulation server 40A is specifically implemented by a workstation, personal computer, or other information processing device. As shown in FIG. 10, the registered image accumulation server 40A includes the registered image accumulation means 100, the image normalization means 101, the variation image generation means 102, the characteristic extraction means 103, the discriminant space projection means 104, the reference person comparison means 105, and a characteristic quantity accumulation means 106. The basic functions of the registered image accumulation means 100, the image normalization means 101, the variation image generation means 102, the characteristic extraction means 103, the discriminant space projection means 104, and the reference person comparison means 105 are the same as the functions of the same components described in Embodiment 1.

The characteristic quantity accumulation means 106 is specifically implemented by a magnetic disk device, an optical disk device, or other database device. The characteristic quantity accumulation means 106 accumulates the characteristic quantity of the registered image that is calculated by the reference person comparison means 105.

The image input terminal 50A is specifically implemented by a workstations personal computer, or other information processing device. As shown in FIG. 10, the image input terminal 50A includes the match image input means 200, the image normalization means 201, the characteristic extraction means 202, the discriminant space projection means 203, the score computation means 301, and the match determination means 302. The basic functions of the match image input means 200, the image normalization means 201, the characteristic extraction means 202, the discriminant space projection means 203, the score computation means 301, and the match determination means 302 are the same as the functions of the same components described in Embodiment 1.

In the present example, the registered image accumulation server 40A calculates the characteristic quantity of the registered image in advance that is accumulated in the registered image accumulation means 100, according to the registered image processing shown in FIG. 2. The registered image accumulation server 40A accumulates the calculated characteristic quantity of the registered image in advance in the characteristic quantity accumulation means 106.

The image input terminal 50A calculates a characteristic quantity of the inputted match image according to the match image processing shown in FIG. 3 when the match image input means 200 is used to input a match image. When the characteristic quantity of the match image is calculated, the image input terminal 50A transmits a request to transmit the characteristic quantity of the registered image to the registered image accumulation server 40A via the network.

When the request to transmit the characteristic quantity is received, the reference person comparison means 105 of the registered image accumulation server 40A extracts the characteristic quantity of the registered image from the characteristic quantity accumulation means 106. The registered image accumulation server 40A transmits the extracted characteristic quantity to the image input terminal 50A via the network.

When the characteristic quantity is received, the image input terminal 50A determines whether the person in the match image is the registered person on the basis of the calculated characteristic quantity of the match image, and the characteristic quantity of the registered image that was received from the registered image accumulation server 40A, according to the identity determination processing shown in FIG. 4.

### INDUSTRIAL APPLICABILITY

Use of the present invention in the field of security can be anticipated through application of the present invention to an entrance/exit management system, a system that uses access control, or the like. The present invention can be applied particularly to a security system that uses a same-person determination system for authenticating the identity of a user through matching of facial images.

1-18. (canceled)

19. A facial image matching method comprising the steps of:
calculating a characteristic quantity for differentiating between a facial image of a specific person and facial images of a plurality of persons other than the specific person;
calculating a degree to which said characteristic quantity is included in a facial image of a person being verified; and
using said degree to match and determine whether said person being verified and said specific person are the same.

20. The facial image matching method according to claim 19, wherein
said step for calculating a characteristic quantity has a step for generating a variation image of the facial image of said specific person, and calculating said characteristic quantity using said variation image and facial images of a plurality of persons other than said specific person.

21. The facial image matching method according to claim 19, wherein
said step for calculating a characteristic quantity has a step for integrating the characteristic quantity of facial images of a plurality of persons other than said specific person and calculating said differentiating characteristic quantity.

22. The facial image matching method according to claim 19, wherein said characteristic quantity is indicated using an axis for performing said differentiation.

23. The facial image matching method according to claim 22, wherein
said matching step comprises performing an analysis to determine whether the characteristic quantity of the facial image of said person being verified is close to any of the characteristic quantity of the facial image of said specific person and a characteristic quantity obtained by integrating the characteristic quantities of facial images of a plurality of persons other than said specific person on said axis, and performing a match to determine whether said person being verified and said specific person are the same.

24. The facial image matching method according to claim 19, wherein
said step for calculating a characteristic quantity comprises calculating said differentiating characteristic quantity using a covariance matrix and an average vector of the characteristic quantity of facial images of a plurality of persons other than said specific person.

25. A facial image matching system comprising:
means for calculating a characteristic quantity for differentiating between a facial image of a specific person and facial images of a plurality of persons other than the specific person;
means for calculating a degree to which said characteristic quantity is included in a facial image of a person being verified; and
means for matching, by using said degree, to determine whether said person being verified and said specific person are the same.

26. The facial image matching system according to claim 25, wherein
said means for calculating a characteristic quantity generates a variation image of the facial image of said specific person, and calculates said characteristic quantity using said variation image and facial images of a plurality of persons other than said specific person.

27. The facial image matching system according to claim 25, wherein
said means for calculating a characteristic quantity integrates the characteristic quantity of facial images of a plurality of persons other than said specific person and calculates said differentiating characteristic quantity.

28. The facial image matching system according to claim 25, wherein said characteristic quantity is indicated using an axis for performing said differentiation.

29. The facial image matching system according to claim 28, wherein
said means for matching performs an analysis to determine whether the characteristic quantity of the facial image of said person being verified is close to any of the characteristic quantity of the facial image of said specific person and a characteristic quantity obtained by integrating the characteristic quantities of facial images of a plurality of persons other than said specific person on said axis, and performs a match to determine whether said person being verified and said specific person are the same.

30. The facial image matching method according to claim 25, wherein
said means for calculating a characteristic quantity calculates said differentiating characteristic quantity using a covariance matrix and an average vector of the characteristic quantity of facial images of a plurality of persons other than said specific person.

31. A facial image matching program for causing a computer to execute:
a routine for calculating a characteristic quantity for differentiating between a facial image of a specific person and facial images of a plurality of persons other than the specific person;
a routine for calculating a degree to which said characteristic quantity is included in a facial image of a person being verified; and
a routine for matching, by using said degree, to determine whether said person being verified and said specific person are the same.

32. The facial image matching program according to claim 31, wherein
said routine for calculating a characteristic quantity has a routine for generating a variation image of the facial image of said specific person, and calculating said characteristic quantity using said variation image and facial images of a plurality of persons other than said specific person.

33. The facial image matching program according to claim 31, wherein
said routine for calculating a characteristic quantity has a routine for integrating the characteristic quantity of facial images of a plurality of persons other than said specific person and calculating said differentiating characteristic quantity.

34. The facial image matching program according to claim 31, wherein said characteristic quantity is indicated using an axis for performing said differentiation.

35. The facial image matching program according to claim 34, wherein
said routine for matching performs an analysis to determine whether the characteristic quantity of the facial image of said person being verified is close to any of the characteristic quantity of the facial image of said specific person and a characteristic quantity obtained by integrating the characteristic quantities of facial images of a plurality of persons other than said specific person on said axis, and performs a match to determine whether said person being verified and said specific person are the same.

36. The facial image matching program according to claim 31, wherein
said routine for calculating a characteristic quantity calculates said differentiating characteristic quantity using a covariance matrix and an average vector of the characteristic quantity of facial images of a plurality of persons other than said specific person.
